(19) United States
(12) Patent Application Publication
(10) Pub. No.: US 2023/0332317 A1
(43) Pub. Date: Oct. 19, 2023

(54) HYDROGEN GENERATION SYSTEM WITH REDUNDANT OXYGEN OR HYDROGEN MONITORING

(71) Applicant: Ohmium International, Inc., Incline Village, NV (US)

(72) Inventors: Chockkalingam Karuppaiah, Fremont, CA (US); Rasool Aghatehrani, Redwood City, CA (US); Jayanth S. Moodliar, Pune (IN)

(21) Appl. No.: 18/136,160

(22) Filed: Apr. 18, 2023

Related U.S. Application Data
(60) Provisional application No. 63/332,174, filed on Apr. 18, 2022.

(51) Int. Cl. C25B 1/04; C25B 15/029

(52) U.S. Cl. CPC C25B 15/029; C25B 1/04

(57) ABSTRACT

The systems and methods described herein provide for a hydrogen generation system that includes one or more gas-detecting sensors for measuring the concentration of gases within or associated with the hydrogen generation system. The obtained measurements may be utilized for many purposes by a controller or control system of the hydrogen generator. When such concentrations are measured, one or more remedial actions may be executed on the generator to prevent the unsafe operating condition. Further, many such safety gas sensors may be associated with a corresponding redundant gas sensor such that measurements from the gas sensor and the redundant gas sensor may be compared to determine a difference between the two measurements which may indicate an operational state of the hydrogen generator. The gas measurements from the sensors may also be analyzed to obtain data and information of an operational status of the hydrogen generator.

### CROSS-REFERENCE TO RELATED APPLICATIONS

This application claims the benefit of U.S. Provisional Pat. Application No. 63/332,174 entitled “REDUNDANT OXYGEN SAFETY MONITORING”, filed on Apr. 18, 2022, the entire contents of which are incorporated herein by reference.

### FIELD OF THE DISCLOSURE

The present disclosure is generally related to a hydrogen generation system that includes control methods and systems for redundant oxygen or hydrogen monitoring.

### BACKGROUND

Electrolysis (i.e., in the context of clean carbon production in the form of hydrogen) is a rapidly growing and enabling technology that provides a preferable and sustainable alternative to fossil fuels and the resulting environmentally harmful CO₂ emissions. Electrolysis may be described as the process of using electricity to split water into hydrogen and oxygen, with this reaction taking place in a unit called an “electrolyzer.”

Through electrolysis, the electrolyzer system creates hydrogen gas which may be used as an energy source, such as in hydrogen-powered vehicles. The leftover oxygen is released into the atmosphere or can be captured or stored to supply other industrial processes or even medical gases in some cases. The hydrogen gas can either be stored as a compressed gas or liquefied, and since hydrogen is an energy carrier, it can be used to power any hydrogen fuel cell electric application, whether it’s trains, buses, trucks, or data centers. The commercial interest in hydrogen fuel (commonly referred to as the fuel cell) is increasing due to the amount of heat that is produced during the electrochemical process.

During this process, hydrogen atoms react with oxygen atoms to form water during oxidation; electrons are released in the process and flow as an electric current through an external circuit. Hydrogen fuel uses the chemical energy of hydrogen to produce electricity as a clean form of energy, with electricity, heat, and water vapor being the only products and byproducts. This process produces zero carbon dioxide, a critical key to reducing greenhouse emissions. Hydrogen fuel cells offer a variety of applications, providing power for automobiles, aircraft, seagoing vessels, and emergency backup power supplies. Hydrogen fuel has additional uses for large stationary (industrial) as well as mobile/portable (personal) applications. Storing hydrogen (I.e., in cryogenic or high-pressure tanks) may present a gating issue in certain applications.

Although generally safe to produce and use, some of hydrogen’s properties may require additional engineering controls to enable its safe use. Specifically, hydrogen has a wide range of flammable concentrations may set the lower explosion limit to levels below that of gasoline or natural gas, which means it can ignite more easily. Consequently, adequate ventilation and leak detection may be important elements in the design of safe hydrogen systems. Thus, there is a need to improve safety monitoring for hydrogen generation systems, including more reliable gas monitoring and automatic shutoff mechanisms for large scale hydrogen and oxygen producers.

### SUMMARY

According to one embodiment, a hydrogen generation system includes a hydrogen generator comprising an electrochemical stack and a plurality of sensors measuring a concentration of hydrogen, oxygen, or a combination thereof generated from the electrochemical stack. The hydrogen generation system also includes a control system comprising a processor and a non-transitory computer-readable medium encoded with instructions, which when executed by the processor, cause the processor to determine an operational status of the hydrogen generator based on the concentration of gas generated from the electrochemical stack and verify the operational status of the hydrogen generator through an additional diagnostic measurement of the electrochemical stack. The instructions also cause the processor to obtain, based on a value of the concentration of gas generated from the electrochemical stack, a rule from a ruleset database and execute a rule from a ruleset to alter an operational parameter of the electrochemical stack based on the determined operational status of the hydrogen generator.

According to another embodiment, a method of operating a hydrogen generation system comprises receiving, from a plurality of sensors measuring a concentration of hydrogen, oxygen, or a combination thereof generated from an electrochemical stack producing hydrogen, determining, an operational status of the electrochemical stack based on the received measurements of concentration of gas, and verifying the operational status of the hydrogen generator through an additional diagnostic measurement of the electrochemical stack. The method also includes obtaining, based on a value of the concentration of gas generated from the electrochemical stack, a rule from a ruleset database and executing a rule from a ruleset to alter an operational parameter of the electrochemical stack based on the determined operational status of the hydrogen generator.

According to yet another embodiment, a non-transitory computer-readable storage medium may have comnputer-executable program instructions stored thereon. When executed by a processor, the program instructions cause a computing device to perform the operations of receiving, from a plurality of sensors measuring a concentration of hydrogen, oxygen, or a combination thereof generated from an electrochemical stack producing hydrogen, determining, an operational status of the electrochemical stack based on the received measurements of concentration of gas, and verifying the operational status of the hydrogen generator through an additional diagnostic measurement of the electrochemical stack. The method also includes obtaining, based on a value of the concentration of gas generated from the electrochemical stack, a rule from a ruleset database and executing a rule from a ruleset to alter an operational parameter of the electrochemical stack based on the determined operational status of the hydrogen generator.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates shows an exemplary environment for hydrogen production according to aspects of the present disclosure.

FIG. 2 illustrates an embodiment of a hydrogen generator for providing hydrogen to one or more downstream receivers.

FIG. 3 illustrates an example block diagram of a controller for a hydrogen generation system with redundant gas sensor monitoring and control.

FIGS. 4A & 4B are example tables of data or information maintained by databases of a hydrogen production environment or system.

FIG. 5 illustrates a method for controlling operation of a hydrogen generator based on measurements received from one or more gas sensors of the generator.

FIG. 6 illustrates a method for controlling operation of a hydrogen generator based on measurements of a pair of redundant gas sensors of the generator.

FIG. 7 illustrates an exemplary computing system which may be used in implementing embodiments of the present disclosure.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the invention, embodiments, or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

The systems and methods described herein provide control of hydrogen generation. In particular, the systems and methods provide for a hydrogen generation system that includes one or more gas-detecting sensors for measuring the concentration of gases within or associated with the hydrogen generation system. In one particular implementation, the gas sensors may detect a concentration of oxygen and/or hydrogen within the system. The obtained measurements may be utilized for many purposes by a controller or control system of the hydrogen generator. For example, gas measurements may be used to detect an unsafe operating condition of the hydrogen generator, such as concentrations of oxygen and/or hydrogen that exceed a minimum safety threshold level. When such concentrations are measured, one or more remedial actions may be executed on the generator to prevent the unsafe operating condition. Further, many such safety gas sensors may be associated with a corresponding redundant gas sensor. Measurements from the gas sensor and the redundant gas sensor may be compared to determine a difference between the two measurements which may indicate an operational state of the hydrogen generator. One or more operational actions, such as replacement of a faulty sensor or a calibration of the sensor, may be triggered based on the determined difference between the measurements. In many instances, however, the determine differences may prevent an incorrect gas concentration measurement that could lead to an unsafe operational condition for the generator.

In some implementations, the gas measurements from the one or more sensors of the hydrogen generator may be analyzed to obtain data and information of an operational status of the hydrogen generator. Further, such processing may be conducted with other diagnostic measurements of the hydrogen generator. For example, some diagnostic measurements may provide an indication of an efficiency of the hydrogen generation or may indicate an imbalance of conditions within the generator. This operational status may be verified through an analysis of gas measurements within the generator. In one implementation, oxygen measurements at an output port of the hydrogen generator may provide an indication of a low efficient operation of the generator, but may then be verified through an analysis of other diagnostic measurements, such as an alternating current (AC) impedance spectroscopy measurement conducted on the hydrogen generator. In general, the gas measurements obtained from the one or more sensors of the hydrogen generator may be utilized to obtain a diagnostic operational status of the generator, particularly along with other diagnostic measurements of the generator.

Some embodiments of this disclosure, illustrating its features, will now be discussed in detail. It can be understood that the embodiments are intended to be open-ended in that an item or items used in the embodiments is not meant to be an exhaustive listing of such items or items or meant to be limited to only the listed item or items.

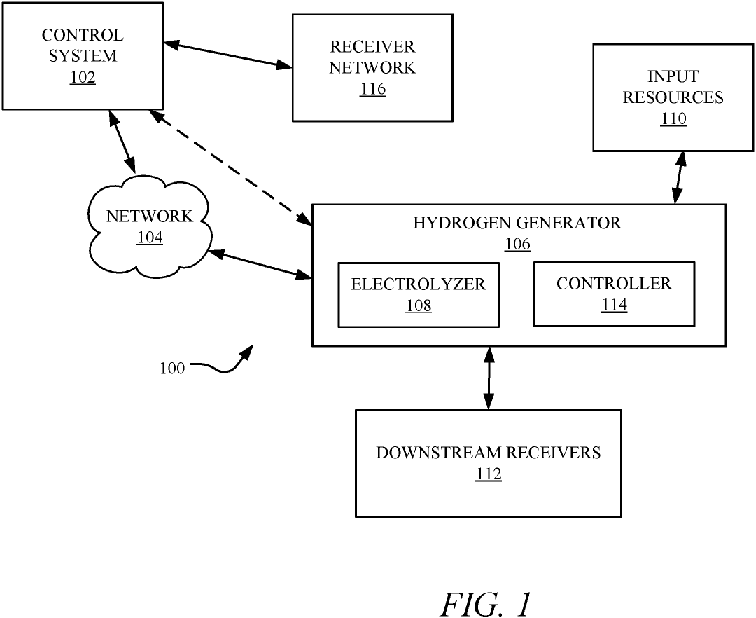

FIG. 1 shows an exemplary environment 100 for hydrogen production according to aspects of the present disclosure. The environment 100 may include more or fewer components than illustrated in FIG. 1, which is included to provide context for the operations and configurations described herein. Additional components and/or configurations of the hydrogen production environment 100 are described in greater detail below.

The environment 100 may include a hydrogen generator 106 designed and configured to generate hydrogen. The hydrogen generator 106 may include a system housed in a container, outdoor-rated cabinets, or multiple systems contained within a site. In one implementation, the hydrogen generator 106 may be a clean hydrogen facility. Such clean hydrogen facility installations are at the early stages of the industry with a significant market growth projection that may scale to much larger production capacity and higher integration adaptation to the upstream and downstream required configurations over time.

As described above, the hydrogen generator 106 generate hydrogen through electrolysis and, more particularly, an electrolyzer or electrolyzer stack 108. The electrolyzer stack 108 is the key equipment component in the hydrogen production process. The quality of the electrolyzer stack 108 determines the operational safety and stability of hydrogen production equipment. The electrolyzer equipment is comprised of various electrolytic cells, and every cell is composed of the main electrode plates, positive net, seal diaphragm gasket, and negative net. An electrolyzer stack, by comparison, comprises multiple cells connected in series in a bipolar design. The stacked bipolar electrolyzer 108 offers a technological engineering solution for the mass production of electrodeposited conducting polymer electrodes for supercapacitors.

Most electrolyzers 108 include an anode and a cathode separated by an electrolyte or membrane in the presence of water. As energy, such as a direct-current (DC) power, is applied, the water molecules react at the anode to form oxygen and positively charged hydrogen ions. With the support of an electrolyzer 108, hydrogen and oxygen may be created from a pure water supply and electrical current. Hydrogen can then be utilized to power a fuel cell stack. In particular, hydrogen ions may flow through the electrolyte of the electrolyzer 108 to the cathode to bond with electrons and form hydrogen gas. The leftover oxygen may be released into the atmosphere or can be captured or stored to supply other industrial processes or even medical gases, in some cases. The hydrogen gas can either be stored as a compressed gas or liquefied, and since hydrogen is an energy carrier, it can be used to power such downstream receivers 112 as hydrogen fuel cell applications like trains, buses, trucks, or data centers. In some instances, the generated hydrogen may be provided to one or more downstream industrial plants for asset production, such as steel, cement, oil, fertilizer, and the like. In one example, liquefied hydrogen may be piped to a downstream receiver 112 or carried by tanker.

Electrolyzers 108 can range in size from small equipment, well-suited for modest-scale distributed hydrogen production to large-scale, central production facilities, capable of being sequenced directly to renewable or other non-greenhouse-gas-emitting forms of electricity production. Electrolyzers 108 offer a route to produce clean hydrogen to power hydrogen fuel cells, supply industrial processes or produce green chemicals like fertilizers, renewable natural gas, and methanol.

As should be appreciated, the hydrogen generator 106 may utilize several input resources 110 for generation of hydrogen. For example, various forms of energy sources (grid electricity, natural gas, wind, solar, hydro, etc.) may be provided to the hydrogen facility for use by the components of the generator. Other input resources 110, such as water for use by the electrolyzer 108 may also be provided to the hydrogen generator 106 for producing hydrogen.

The hydrogen generator 106 may include several components in addition to the electrolyzer 108. Control over the various components, systems, programs, and/or sensors of the generator 106 may be executed through a controller 114. For example, a Supervisory Control and Data Acquisition (SCADA) control system may be integrated with the hydrogen generator 106 to monitor generator conditions and/or control various aspects or parameters of the components of the generator. In one particular instance, a sensor may be associated with a pipe containing gas generated from the electrolysis process to measure the pressure within the pipe. The sensor may provide readings or measurements to the controller 114 which may, in response, adjust one or more valves within the gas piping system to adjust the pressure within the piping system. In general, any adjustable aspect or parameter of the hydrogen generator, the components within the generator, input resources 110, sensors, executable program associated with the generator, or any other aspect of the hydrogen generator 106 may be adjustable by the controller 114. In some instances, the controller 114 may also include an interface through which a generator operator may access components of the generator 106 and make one or more adjustments to the components. In another instance, the controller 114 may be configured to automatically adjust the parameters or aspects of the hydrogen generator 106 based on inputs from one or more sensors or any other source of operational data of the generator. Additional details of the controller 114 and the hydrogen generator 106 in general are discussed in more detail below.

The environment 100 may also, in some instances, include a remote or separate control system 102 that communicates with the hydrogen generator 106 either directly or through a network 104 connection. In one example, the control system 102 may be in communication with the electrolyzer 108 to monitor one or more operational states of the electrolyzer and adjust one or more parameters of the electrolyzer accordingly. In other examples, the control system 102 may be in communication with a plurality of hydrogen generators 106 connected together or separate. In general, the control system 102 may be in communication with any number of hydrogen generators 106, each of which may generate some hydrogen as controlled by the control system 102 or by a local controller for the hydrogen generator. The plurality of hydrogen generators may therefore be controlled by the control system 102 to provide a requested amount of hydrogen for one or more downstream receivers 112.

The network 104 may connect the control system 102 to one or more communication interface devices of the hydrogen generator 106 and may be configured to transmit and/or receive information between the remote monitoring system and other devices by way of one or more wired or wireless communication networks or connections. Examples of such networks or connections include, without limitation, wireline communication over serial or Ethernet in copper or fiber medium or wireless communication over USB, Wi-Fi, Bluetooth, Zigbee mesh network, or a cellular wireless network. One or more such communication interface devices may be utilized to communicate with the remote monitoring system 102 and/or the hydrogen generator 106, either directly over a point-to-point communication path, over a wide area network (WAN) (e.g., the Internet), over a local area network (LAN), over a cellular (e.g., third generation (3G), fourth generation (4G), fifth generation (5G)) network, or over another communication means. In some instances, the control system 102 may directly connect to the hydrogen generator 106, such as through a cable connection or backplane connection between the control system and the generator.

The environment 100 of FIG. 1 may also include a receiver network 116 or customer network, which allows receivers of the generated hydrogen to provide requests for hydrogen to the control system 102 or to communicate with the control system in any manner. The receiver network 116 generally allows receivers or users to share information or data with the control system 102 and/or controller 114. For example, the receiver network 116 may receive a request for hydrogen from a system or user associated with a downstream receiver 112. A request module of the receiver network 116 may generate and send a request to the control system 102 activate the electrolyzer 108 of the hydrogen generator 106 to generate hydrogen for the downstream receiver. The receiver network 116 may also include one or more databases storing information associated with the request and receipt of hydrogen from the hydrogen generator 106, such as a client name, the number of electrochemical stacks the customer is currently associated with, and current and past requests for hydrogen, including an amount requested, the date, and the time. Such information may also be maintained by the control system 102 for one or many downstream receivers 112. In other examples, hydrogen requests may be automated by the receiver network 116 and transmitted to the control system 102 either periodically or aperiodically, such as in response to one or more operating conditions of the downstream receiver 112.

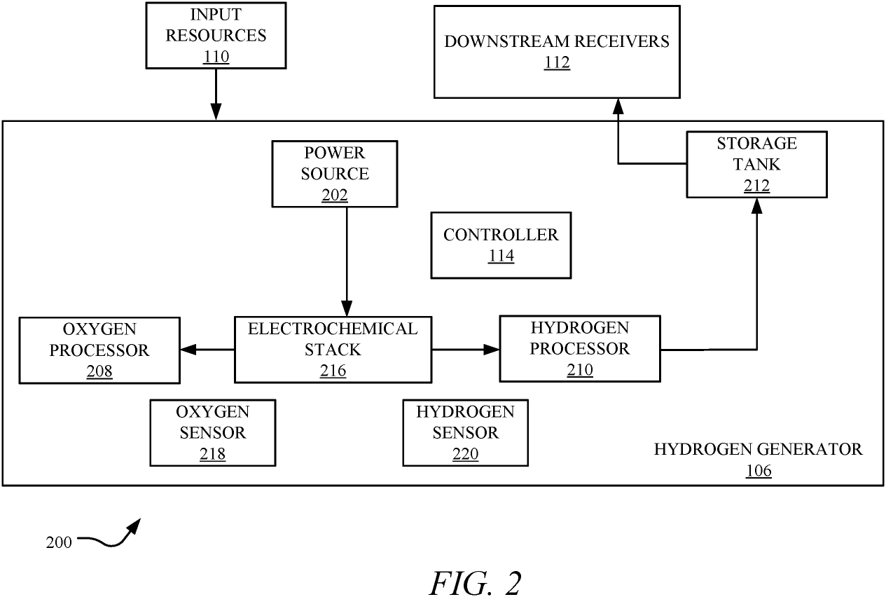

FIG. 2 illustrates an embodiment of the hydrogen generator 106 of the environment 100 discussed above for providing hydrogen to one or more downstream receivers 112, such as industrial plants or other receivers. The hydrogen generator 106 may be the same or similar to that described above with reference to FIG. 1. However, in this illustration, additional components of the hydrogen generator 106 is illustrated, such as an oxygen processor 208, an electrochemical stack 216 (which may include an electrolyzer 108 as discussed above), one or more gas sensors (such as oxygen sensor 218 and hydrogen sensor 220), and a hydrogen processor 210. The oxygen processor 208, the electrochemical stack 216, and the hydrogen processor 210 are fluidically isolated from each other with at least one fluid connector fluidly connecting the oxygen processor and the electrochemical stack and at least one fluid connector fluidly connecting the electrochemical stack and the hydrogen processor. As further discussed below, the hydrogen generator 106 may also include a power source 202, a plurality of gas movers, a controller 114, and a storage tank 212, among other components and systems.

In some instances, the electrochemical stack 216 may include a first membrane electrode assembly (MEA), a second membrane electrode assembly (MEA), and a bipolar plate that collectively defines two complete electrochemical cells for hydrogen generation. The electrochemical stack 216 may also include a first end plate and a second end plate that may sandwich the first MEA, the second MEA, and the bipolar plate into contact with one another and direct the flow of fluids into and out of the electrochemical stack. While the electrochemical stack 216 is described as including two complete cells—a single bipolar plate and two MEAs-it should be appreciated that this is for the sake of clarity of explanation only. The electrochemical stack 216 may alternatively include any number of MEAs and bipolar plates useful for meeting the hydrogen generation demands of the system 200 while maintaining separation between pressurized hydrogen and lower pressure water and oxygen flowing through the electrochemical stack, unless otherwise specified or made clear from the context. The electrochemical stack 216 may include more than one bipolar plate, a single MEA, and/or more than two MEAs. In some embodiments, the bipolar plate may be disposed between the first end plate and the first MEA and/or between the second end plate and the second MEA, without departing from the scope of the present disclosure.

In some embodiments, the first MEA and the second MEA of the electrochemical stack 216 may be identical. For example, the first MEA may include an anode, a cathode, and a proton exchange membrane (e.g., a PEM electrolyte) therebetween. Similarly, the second MEA may include an anode, a cathode, and a proton exchange membrane therebetween. The anodes may each comprise an anode catalyst (i.e., electrode) contacting the membrane and an optional anode fluid diffusion layer. The cathodes may each comprise a cathode catalyst (i.e., electrode) contacting the membrane and an optional cathode gas diffusion layer. The anode electrode may comprise any suitable anode catalyst, such as an iridium layer. The anode fluid diffusion layer may comprise a porous material, mesh or weave, such as a porous titanium sheet or a porous carbon sheet. The cathode electrode may comprise any suitable cathode catalyst, such as a platinum layer. The cathode gas diffusion layer may comprise porous carbon. Other noble metal catalyst layers may also be used for the anode and/or cathode electrodes, including but not limited to ruthenium, rhodium, palladium, osmium, iridium, gold, and silver. The electrolyte may comprise any suitable proton exchange (e.g., hydrogen ion transport) polymer membrane.

The bipolar plate may be disposed between the cathode of the first MEA and the anode of the second MEA. In general, the bipolar plate may include a substrate, an anode gasket, and a cathode gasket. The substrate has an anode (i.e., water) side and a cathode (i.e., hydrogen) side opposite one another. The anode gasket may be fixed to the anode side of the substrate, and the cathode gasket may be fixed to the cathode side of the substrate. Such fixed positioning of the anode gasket and the cathode gasket on opposite sides of the substrate may facilitate forming two seals that are consistently placed relative to one another and relative to the first MEA and the second MEA on either side of the bipolar plate. The gaskets form a double seal around the active areas (i.e., anode (e.g., water) flow field and cathode (e.g., hydrogen) flow field) located on respective opposite sides of the bipolar plate. Further, or instead, in instances in which an electrochemical stack 216 includes an instance of an MEA between two instances of the bipolar plate, the anode gasket and the cathode gasket may form a double seal along an active area of the MEA. Thus, more generally, it shall be appreciated that the anode gasket and the cathode gasket may form a sealing engagement with one or more MEAs in an electrochemical stack to isolate flows within the electrode stack and, thus, reduce the likelihood that pressurized hydrogen may inadvertently mix with a flow of water and oxygen exiting the electrochemical stack 216 to create a combustible hydrogen-oxygen mixture in the system 200.

The substrate may be formed of any one or more of various types of materials that are electrically conductive, thermally conductive, and have strength suitable for withstanding the high pressure of hydrogen flowing along the cathode side of the substrate during use. Thus, for example, the substrate may be at least partially formed of one or more of plasticized graphite or carbon composite. Further, or instead, the substrate may be advantageously formed of one or more materials suitable for withstanding prolonged exposure to water on the anode side of the substrate. Accordingly, in some instances, the anode side of the substrate may include an oxidation inhibitor coating that is electrically conductive, examples of which include titanium, titanium oxide, titanium nitride, or a combination thereof. The oxidation inhibitor may generally extend at least along those portions of the anode side of the substrate exposed to water during the operation of the electrochemical stack 216. The oxidation inhibitor may extend at least along the anode flow field inside the anode gasket on the anode side of the substrate. In some implementations, the oxide inhibitor may extend along the plurality of anode ports (i.e., water riser openings) which extend from the anode side to the cathode side of the substrate. The oxidation inhibitor may also be located in the anode plenums, which connect the anode ports to the anode flow field on the anode side of the substrate.

A cathode ring seal may be located around each cathode port (i.e., hydrogen riser opening) on the anode side of the substrate of the electrochemical stack 216. The cathode ring seal prevents hydrogen from leaking out into the anode flow field on the anode side of the substrate. In contrast, an anode ring seal may be located around each one or more anode ports on the cathode side of the substrate. For example, two anode ports are surrounded by a common anode ring seal to prevent water from flowing into the cathode flow field on the cathode side of the substrate.

The anode flow field may include a plurality of straight and/or curved ribs separated by flow channels oriented to direct a liquid (e.g., purified water) between at least some of the plurality of anode ports, such as may be useful for evenly distributing purified water along the anode of the second MEA. The anode gasket may circumscribe the anode flow field and the plurality of anode ports along the anode side of the substrate to limit the movement of purified water moving along the anode. The anode side of the substrate may be in sealed engagement with the anode of the second MEA via the anode gasket, such that anode channels are located therebetween. Under pressure provided by a source external to the electrochemical stack 216 (e.g., such as the pump of the oxygen processor 208), a liquid provided from the first fluid connector flows along the anode channels is directed across the anode of the second MEA, from one instance of the plurality of anode ports to another instance of the plurality of anode ports, where the liquid (e.g., remaining water and oxygen) may be directed out of the electrochemical stack through a third fluid connector.

Additionally, the substrate may include a plurality of cathode ports (i.e., hydrogen riser openings), each extending from the anode side to the cathode side of the substrate. The cathode side of the substrate may include a cathode flow field. The cathode flow field may include a plurality of straight and/or curved ribs separated by cathode flow channels oriented to direct gas (e.g., hydrogen) toward the plurality of cathode ports, which may be useful for directing pressurized hydrogen formed along with the cathode of the first MEA. Cathode plenums may be located between the cathode ports and the cathode flow field. The cathode gasket may circumscribe the cathode flow field, the cathode plenums, and the plurality of cathode ports along the cathode side of the substrate to limit movement of the pressurized hydrogen along the cathode. For example, the cathode side of the substrate may be in sealed engagement with the cathode of the first MEA via the cathode gasket, such that the cathode flow channels are defined between the cathode of the first MEA and the cathode side of the substrate. The pressure of the hydrogen formed along the cathode may move the hydrogen along at least a portion of the cathode channels and toward the cathode ports located diagonally opposite the cathode inlet port. The pressurized hydrogen may flow out of the cathode ports and out of the electrochemical stack 216 through the second fluid connector to be processed by the hydrogen circuit.

The anode gasket on the anode side of the substrate and the cathode gasket on the cathode side of the substrate may have different shapes. For example, the anode gasket may extend between the plurality of anode ports and the plurality of cathode ports on the anode side of the substrate. In other words, the anode gasket surrounds the anode ports and the anode flow field on one lateral side but leaves the cathode portions outside its circumscribed area. Therefore, the anode gasket may fluidically isolate anode flow from cathode flow in an installed position.

In contrast, the cathode gasket on the cathode side of the substrate may not extend between the plurality of anode ports and the plurality of cathode ports. In other words, the cathode gasket surrounds the anode ports, the cathode portions, and the cathode flow field. Instead, the anode ring seals isolate the anode ports from the cathode ports and the cathode flow field on the cathode side of the substrate.

In one configuration, the anode flow field and the cathode flow field may have the same shape, albeit on the opposite side of the substrate, to provide the same active area along with the first MEA and the second MEA. Thus, taken together, it shall be appreciated that the differences in shape between the anode gasket and the cathode gasket along with positioning of the anode ring seals and the same shape of the anode flow field and the cathode flow field may result in different sealed areas. These different sealed areas are complementary to one another to facilitate fluidically isolating the lower pressure flow of purified water along the anode channels from the pressurized hydrogen flowing along the cathode channels while nevertheless allowing each flow to move through the electrochemical stack 216 and ultimately exit the electrochemical stack along different channels.

In certain implementations, the cathode flow field may be shaped such that a minimum bounding rectangle of the cathode flow field is square. As used in this context, the term “minimum bounding rectangle” shall be understood to be a minimum rectangle defined by the maximum x- and y-dimensions of a cross-section of the cathode flow field. The plurality of cathode ports may include two cathode ports per substrate which are located in diagonally opposite corners from one another with respect to the minimum bounding rectangle (e.g., within the minimum bounding rectangle). The other two diagonally opposite corners lack the cathode ports. In instances in which the minimum bounding rectangle is square, the diagonal positioning of the cathode ports relative to the minimum bounding rectangle may facilitate the flow of pressurized hydrogen diagonally along the entire cathode flow field while leaving a large margin of the substrate material for strengths against the contained internal hydrogen pressure. Alternatively, the substrate may be a rectangle. The plurality of cathode ports may be positioned away from the edges of the substrate such that each one of the plurality of cathode ports is well-reinforced by the material of the substrate between the respective one of the plurality of cathode ports and the closest edge of the substrate.

Given the large pressure differential between the flow of pressurized hydrogen along the cathode channels and the flow of water and oxygen along the anode channels, the electrochemical stack 216 may include the anode fluid diffusion layer disposed in the anode channels and optionally between the anode electrode of the anode of the second MEA and the anode side (e.g., anode ribs) of the substrate. The porous material of the anode fluid diffusion layer may generally permit the flow of water and oxygen through the anode channels without a substantial increase in flow restriction through the anode channels while providing structural support on the anode side of the substrate to resist collapse that may result from the pressure difference on opposite sides of the substrate. It shall be understood, however, the that porous material may be disposed inside all of the anode channels in certain implementations.

Having described various features of the electrochemical stack 216, attention is now directed to a description of the operation of the electrochemical stack to form pressurized hydrogen with water and electricity as inputs. In particular, an electric field E (i.e., voltage) may be applied across the electrochemical stack 216 (i.e., between the end plates) from the power source 202. The bipolar plate may electrically connect the first MEA and the second MEA in series with one another such that electrolysis may take place at the first MEA and the second MEA to form a flow of pressurized hydrogen that is fluidically isolated from lower pressure water and oxygen, except for proton exchange occurring through the proton exchange membrane.

Purified water (not shown) may be introduced into the electrochemical stack 216 via a fluid connection between the oxygen processor and electrochemical stack. Within the electrochemical stack 216, the purified water may flow along an intake channel to direct the purified water to the anode of the first MEA and the anode of the second MEA. With the electric field E applied across the anode and the cathode of the first MEA, the purified water may break down along the anode into protons (H⁺) and oxygen. The protons (H⁺) may move through the proton exchange membrane from the anode to the cathode. At the cathode, the protons (H⁺) may combine to form pressurized hydrogen along the cathode. Through an analogous process, pressurized hydrogen may also be formed along the cathode of the second MEA. The flows of pressurized hydrogen formed by each of the first MEA and the second MEA may combine and flow out of the electrochemical stack 216 via two hydrogen exhaust channels that extends through the bipolar plate, among other components, to ultimately direct the pressurized hydrogen toward the hydrogen processor 210. The flows of oxygen and water along the first anode and the second anode may combine and flow out of the electrochemical stack 216 via the outlet anode ports and an outlet channel to direct this stream of water and oxygen toward the oxygen processor 208.

Some implementations of the hydrogen generator 106 may include a plurality of gas movers that include one or more of various types of fans (e.g., purge fans), blowers, or compressors. In some implementations, each one of the plurality of gas movers may be disposed within the electrochemical stack 216 or, alternatively, each one of the plurality of gas movers may be mounted externally to the electrochemical stack (e.g., to the roof or sidewall of the cabinet) to reduce the potential for heat or sparks to act as an inadvertent ignition source for contents of the generator.

The hydrogen generator 106 may also include an oxygen sensor 218 to measure or otherwise determine a level of oxygen in the hydrogen pipes, pathways, ducts, etc., located in the various components of the hydrogen generator. In some embodiments, the oxygen sensor 218 may be located in the oxygen pipes, pathways, ducts, etc., exiting the electrochemical stack 216. In one particular implementation, the oxygen sensor 218 may be located at an egress port of the hydrogen generator 106 through which oxygen from the oxygen processor 208 is released into the air. In general, the oxygen sensor 218 may be an electronic device that measures the proportion of oxygen in the gas being analyzed. The oxygen sensor 218 may use technologies such as zirconia, electrochemical, infrared, ultrasonic, paramagnetic, laser methods, etc.

The oxygen sensor may include a zirconia sensor. The zirconia sensor may be a sensor based on the solid-state electrochemical fuel cell called the Nernst cell, and its two electrodes provide an output voltage corresponding to the quantity of oxygen in the exhaust relative to that in the atmosphere.

The oxygen sensor may include an electro-galvanic oxygen sensor. The electro-galvanic oxygen sensor may be a sensor to measure the oxygen concentration by measuring the voltage generated by a small electro-galvanic fuel cell.

The oxygen sensor may include an oxygen optode. The oxygen optode is a sensor based on optical measurement of the oxygen concentration. A chemical film is glued to the tip of an optical cable, and the fluorescence properties of this film depend on the oxygen concentration. Fluorescence is at a maximum when there is no oxygen present. The higher the concentration of oxygen, the shorter the lifetime of the fluorescence. When an oxygen molecule collides with the film, it quenches the photoluminescence. In a given oxygen concentration, there will be a specific number of oxygen molecules colliding with the film at any given time, and the fluorescence properties will be stable.

The hydrogen generator 106 may also include a hydrogen sensor 220 to measure a level of hydrogen in the pipes, pathways, ducts, etc., exiting the electrochemical stack 216. The hydrogen sensor 220 may be a different type of technology than the technology used for the oxygen sensor 218. For example, the hydrogen sensor 220 may be a gas detector that detects the presence of hydrogen. Some examples of hydrogen sensors 220 include, but are not limited to, an electrochemical hydrogen sensor, a microelectromechanical system (MEMS) hydrogen sensor, thin-film sensor, thick-film sensor, chemochromic hydrogen sensor, diode base Schottky sensor, etc.

The hydrogen sensor may include an electrochemical hydrogen sensor. The electrochemical hydrogen sensor may be used in which low (ppm) hydrogen gas levels can be sensed using electrochemical sensors, which comprise an array of electrodes packaged to be surrounded by a conductive electrolyte and gas ingress controlled with a diffusion-limited capillary.

The hydrogen sensor may include a MEMS hydrogen sensor. The MEMS hydrogen sensor may be the combination of nanotechnology, and MEMS technology that allows the production of a hydrogen microsensor that functions properly at room temperature. One type of MEMS-based hydrogen sensor is coated with a film consisting of nanostructured indium oxide and tin oxide. A typical configuration for mechanical Pd-based hydrogen sensors is the usage of a free-standing cantilever that is coated with Pd. In the presence of H₂, the Pd layer expands and thereby induces stress that causes the cantilever to bend. Some implementations may include Pd-coated nanomechanical resonators that rely on the stress-induced mechanical resonance frequency shift caused by the presence of H₂ gas. In this case, the response speed may be enhanced through the use of a very thin layer of Pd (20 nm).

The hydrogen sensor may include a thin-film sensor that may include a metallic film vacuum deposited on an insulating substrate. In one implementation, the thin-film sensor may have a palladium thin-film sensor based on an opposing property that depends on the nanoscale structures within the thin film. In the thin film, nanosized palladium particles swell when the hydride is formed, and in the process of expanding, some of them form new electrical connections with their neighbors. The resistance decreases because of the increased number of conducting pathways.

The hydrogen sensor may include a thick-film sensor that may include a paste fired onto an insulating substrate. The thick film sensor may include devices usually having two principal components: a thick layer of some semiconductor material called a matrix, and an upper layer of catalytically active additives like noble metals and metal oxides accelerating the hydrogen oxidation reaction on the surface which makes the sensor response much faster.

The hydrogen sensor may include a chemochromic hydrogen sensor. The chemochromic hydrogen sensor may be reversible, and irreversible chemochromic hydrogen sensors include a smart pigment paint that visually identifies hydrogen by a change in color.

The hydrogen sensor may include a Schottky diode-based hydrogen gas sensor. The diode-based Schottky sensor may be a Schottky diode-based hydrogen gas sensor that employs a palladium-alloy gate. Hydrogen can be selectively absorbed in the gate, lowering the Schottky energy barrier.

As described above, the hydrogen generator 106 may also include a controller 114, which may be in electrical communication at least with one or more components of the generator. In general, the controller 114 may include one or more processors and a non-transitory computer-readable storage medium having stored thereon instructions for causing the one or more processors to control one or more of the startup, operation, or shutdown of any one or more of various aspects of the system 200 to facilitate safe and efficient operation. For example, the controller 114 may be in electrical communication at least with the electrochemical stack 216 and the power source 202. Continuing with this example, the controller 114 may interrupt power to the electrochemical stack 216 if an anomalous condition is detected. Further, or instead, the controller 114 may control the power to the electrochemical stack 216 after a startup protocol to reduce the likelihood of igniting a hydrogen-containing mixture in the electrochemical stack.

In certain implementations, the controller 114 may further, or instead, monitor one or more ambient conditions of the hydrogen generator 106 to facilitate taking one or more remedial actions before an anomalous condition results in damage to the system 200 and/or to an area near the system. In one particular example, given the potential damage that may be caused by the presence of an ignitable hydrogen-containing mixture within the electrochemical stack 216, the system 200 may include the plurality of gas sensors 218, 220. Each of the plurality of gas sensors 218, 220 may include any one or more of various types of hydrogen sensors and/or oxygen sensors. One or more of the plurality of gas sensors 218, 220 may be calibrated to detect hydrogen concentration levels below the ignition limit of hydrogen to facilitate taking remedial action before an ignition event can occur. In another example, one or more of the plurality of gas sensors 218, 220 may be calibrated to detect oxygen concentration levels below the ignition limit of oxygen. The detected levels of hydrogen and/or oxygen may be utilized, along with other measurements obtained from the hydrogen generator 106 to determine one or more operating conditions of the hydrogen generation system 100. Toward this end, the controller 114 of the hydrogen generator 106 may be in electrical communication with each one of the plurality of gas sensors. The non-transitory computer-readable storage media of the controller 114 may have stored thereon instructions for causing one or more processors of the controller to interrupt electrical communication between the power source 202 and equipment in the electrochemical stack 216 based on a signal, received from one or more of the plurality of gas sensors and indicative of a dangerous hydrogen concentration. Additionally, or alternatively, the signal received from one or more of the plurality of gas sensors may indicate a rapid increase in hydrogen concentration. The controller 114 may also communicate the received signals from the one or more sensors 218, 220 to the control system 102 for further processing, as described in more detail below. In general, the controller 114 may respond to any measured or detected condition of the hydrogen generator 106 and control one or more components of the generator accordingly.

In some implementations, the hydrogen generator 106 may be coupled to an external water source (e.g., water pipe, not shown) to receive a water supply suitable for meeting the demands of the electrochemical stack 216. The connection between the hydrogen generator 106 and the external water source may facilitate connection of the system 200 to an industrial water supply and, in some instances, to reduce the likelihood of damaging equipment in the event of a leak in the connection between the external water source. In still other implementations, the hydrogen generator 106 may include a recirculation circuit to receive an exit flow of water and oxygen from the anode portion of the electrochemical stack 216. One or more of the oxygen sensors 218 may be connected to or otherwise in communication with the hydrogen generator 106 to measure or determine an exit flow of oxygen from the generator. The levels of exit flow oxygen may provide an indication of an operating state of the generator and may also be used to indicate an unsafe operating condition of the generator.

One or more of various gas-liquid separators suitable for separating oxygen from excess water may be included in the oxygen processor 208. For example, the oxygen processor 208 may include a dryer, a condenser, or another device that separates oxygen from excess water through gravity. The excess water may settle along a bottom portion of the oxygen processor 208, and oxygen is collecting along the top. The oxygen collected by the oxygen processor 208 may be measured by one or more oxygen sensors 218 and directed out of the hydrogen generator 106. In some instances, redundant oxygen sensors 218 may detect the amount of oxygen of the oxygen processor 208 to ensure that the detection of oxygen of the oxygen processor 208 is accurate, as described in more detail below.

Further, embodiments may include a hydrogen processor 210, which may include a hydrogen circuit, a dryer, and a hydrogen pump. In use, a product stream consisting of hydrogen and water (e.g., water vapor) may move from the anode side of the electrochemical stack 216 to the inlet portion of a dryer. The dryer may be, for example, pressure swing adsorption (PSA), a temperature swing adsorption (TSA) system, or a hybrid PSA-TSA system. The dryer may include one or more beds of a water-adsorbent material, such as activated carbon, silica, zeolite, or alumina. As the product mixture consisting of hydrogen and water moves through from the inlet portion to an outlet portion of the dryer, at least a portion of the water may be removed from the product mixture through adsorption of either water or hydrogen in the bed of water-adsorbent material.

The hydrogen pump may be, for example, an electrochemical pump. As used in this context, an “electrochemical pump” shall be understood to include a proton exchange membrane (i.e., a PEM electrolyte) disposed between an anode and a cathode. The hydrogen pump may generate protons moveable from the anode through the proton exchange membrane to the cathode to form pressurized hydrogen. Thus, such an electrochemical pump may be particularly useful for recirculating hydrogen within the hydrogen circuit at least because the electrochemical pumping provided by the electrochemical pump separates hydrogen from water in the mixture delivered to the hydrogen pump via the pump conduit while also pressurizing the separated hydrogen to facilitate moving the pressurized hydrogen to the inlet portion of the dryer.

Some embodiments may include storage tank 212, which may include a plurality of hydrogen storage tanks to contain the hydrogen created from the hydrogen processor 210. The storage tank 212 may be used to store excess hydrogen created by the hydrogen processor 210 to be used or shipped to users at a later time. In some instances, the produced hydrogen may not be stored in a storage tank but may instead be directly provided to an end user or to a storage tank external to the hydrogen generator. The storage tank 212 may be used to contain hydrogen until shipped to users, such as industrial outputs, among other users.

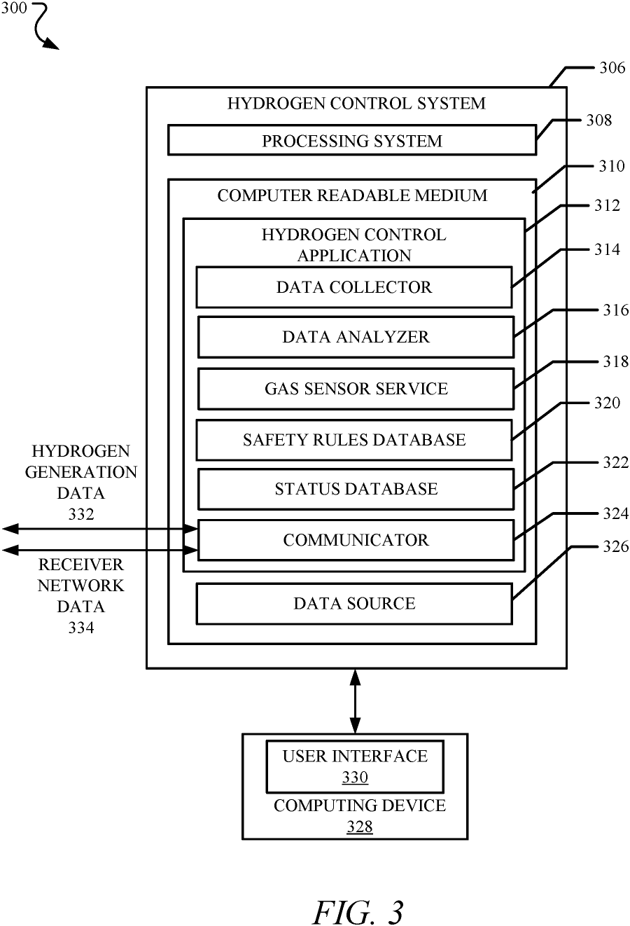

FIG. 3 illustrates an example block diagram of a controller for a hydrogen generation system with gas sensor control and monitoring. In general, the system 300 may include a hydrogen control system 306. In one implementation, the hydrogen control system 306 may be a part of the hydrogen generation environment 100 of FIG. 1. As shown in FIG. 3, the hydrogen control system 306 may be in communication with a computing device 328 providing a user interface 330. As explained in more detail below, the hydrogen control system 306 may be accessible to various users to request hydrogen for any number of downstream receivers 112. In some instances, access to the hydrogen control system 306 may occur through the user interface 330 executed on the computing device 328.

The hydrogen generation system 306 may include a hydrogen generation application 312 executed to perform one or more of the operations described herein. The hydrogen generation application 312 may be stored in a computer readable media 310 (e.g., memory) and executed on a processing system 308 of the hydrogen generation system 306 or other type of computing system, such as that described below. For example, the hydrogen generation application 312 may include instructions that may be executed in an operating system environment, such as a Microsoft Windows® operating system, a Linux operating system, or a UNIX operating system environment. By way of example and not limitation, non-transitory computer readable medium 310 comprises computer storage media, such as non-transient storage memory, volatile media, nonvolatile media, removable media, and/or non-removable media implemented in a method or technology for storage of information, such as computer readable instructions, data structures, program modules, or other data.

The hydrogen generation application 312 may also utilize a data source 326 of the computer readable media 310 for storage of data and information associated with the hydrogen generation system 306. For example, the hydrogen generation application 312 may store received data or inputs, processing details, and/or output information, and the like. As described in more detail below, data associated with hydrogen production, including oxygen sensor measurements, hydrogen sensor measurements, alternating current (AC) impedance spectroscopy measurements, and the like, may be stored and accessed via the user interface 330. Data associated with a safety procedure of the hydrogen generation may also be stored at the data source 326.

To provide gas analysis services for hydrogen, the hydrogen generation application 312 may include several components that are be executed to process one or more gas measurements of the hydrogen generator 106 and control an operating state of the generator in response. For example, the hydrogen generation application 312 may include a data collector 314 to collect and store data from the hydrogen generator 106 and the receiver network 116. In some embodiments, the data collector 314 may utilize a communicator 324 of the hydrogen control application 312 to communicate with the hydrogen generator 106 and/or the receiver network 116 to receive said data. For example, the communicator 324 may communicate with the receiver network 116 to receive a request for hydrogen production received at a downstream system 112. The received request may be stored in the data source 326 (or some other data storage device) by the data collector 314. The hydrogen control application 312 may also, in response to receiving the request, transmit one or more control instructions to the hydrogen generator 106 to generate hydrogen for the downstream receiver 112. The data collector 314 may store data associated with any aspect of the generation of hydrogen, including hydrogen generation data 332 received from one or more hydrogen generators 106 and receiver network data 334 received from a receiver network corresponding to hydrogen generated for a downstream receiver 112.

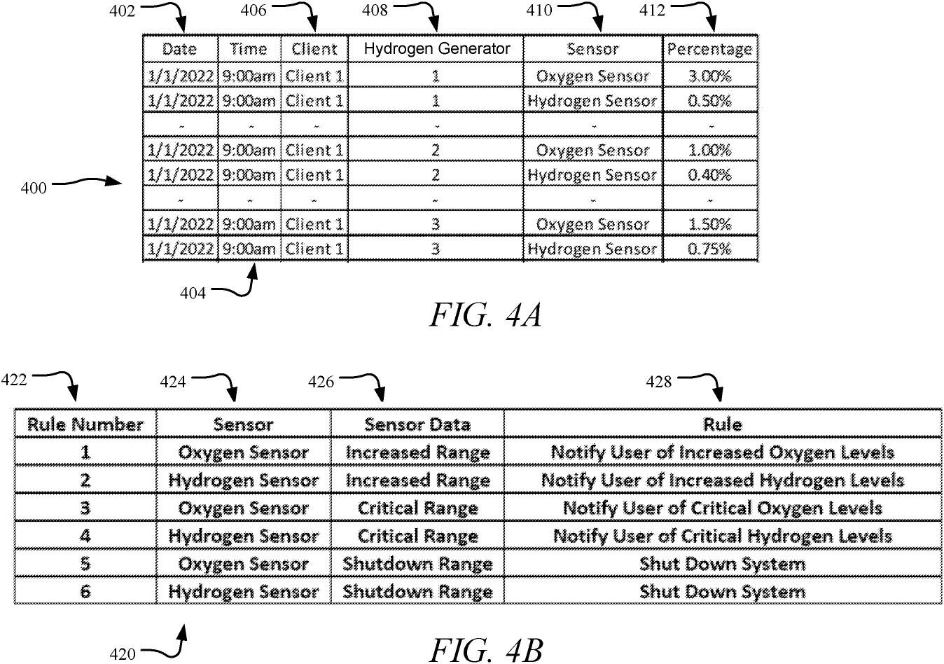

Further embodiments may include a data analyzer 316 to analyze and/or otherwise process data stored by the data collector. In one implementation, the data analyzer 316 may obtain data from any of the databases managed by or otherwise in communication with the data collector 314. For example, the hydrogen control application 312 may maintain a historical database of gas sensor measurements for one or more sensors of one or more hydrogen generators. FIG. 4A illustrates one example of such a historical database 400. As illustrated, the historical database 400 may include entries for a date 402 and time 404 of receipt of a gas measurement from one or more of the gas sensors 218, 220 of a hydrogen generator 106 of a hydrogen generating system 100, a client 406 associated with the hydrogen generator (such as a downstream receiver 112), an identifier of a hydrogen generator 408, a type of gas sensor (such as an oxygen sensor or a hydrogen sensor), and/or a measurement of a gas corresponding to the type of gas sensor. More or less data may be stored in the historical database 400 and the data may be stored in any format, not necessarily in a table as illustrated in FIG. 4A. The data included in the historical database 400 may be generated by the hydrogen control application 312 or obtained from the hydrogen generator 106 and/or the receiver network 116. As mentioned above, the control system 102 may be connected to any number of hydrogen generators 106 and each generator may include one or more gas sensors. As such, each stored measurement of the gas sensors may be associated with a hydrogen generator connected to or in communication with the control system 102, as illustrated in column 408. Further, for each hydrogen generator 106, more than one sensor and/or more than one type of sensor may provide measurement of gas within the hydrogen generator, such as at an ingress port of the oxygen processor 208 or at or near the hydrogen processor 210. Thus, the historical database 400 may include both oxygen sensor measurements and hydrogen sensor measurements, taken from multiple hydrogen generators at various times and dates. This data may be processed by the data analyzer 316 of the hydrogen control application 312, as explained in more detail below.

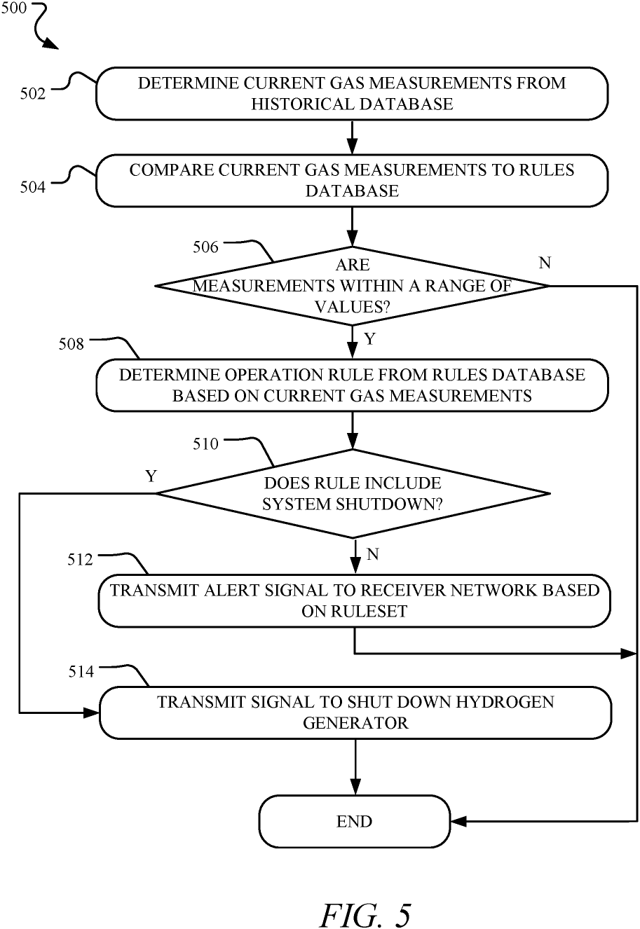

The hydrogen control system 306 may also include a gas sensor service 318 and safety rules database 320 to manage operations of one or more hydrogen generators 106 based on gas measurements and other measurements obtained from the hydrogen generators. In one particular example, the gas sensor service 318 of the hydrogen control application 312 may control operation of a hydrogen generator to prevent an unsafe operating condition of the generator. FIG. 5 illustrates one such method 500 for providing gas sensor services for a hydrogen generator 106 or generators. In one implementation, the operations of the method 500 may be performed or executed by the gas sensor service 318 of the hydrogen control application 312 as executed by the control system 102. In general, however, the operations may be performed by any component or components of the hydrogen generation environment 100 of FIG. 1, including the controller 114 of the hydrogen generator 106 and/or a system of the receiver network 116.

At operation 502, a current or most recent gas measurement may be obtained from a database, such as the historical database 400 illustrated in FIG. 4A. The collected data may include oxygen measurements from one or more oxygen sensors 218, hydrogen measurements from one or more hydrogen sensors 220, and/or measurements from other gas sensors of the hydrogen generator 106. The gas sensors 218, 220 may be located in various portions of the hydrogen generator 106 to obtain gas measurements that the various locations. In some implementations, each sensor 218, 220 may include a redundant sensor to obtain redundant gas readings from the same or similar location within or associated with the hydrogen generator 106. For example, a main oxygen sensor 218 and a redundant, back-up oxygen sensor may be associated with the oxygen processor 208 of the generator 106. Each of the main sensor and the redundant sensor may provide gas measurements for storage in the historical database 400. As explained in more detail below, the redundant sensor may provide added safety for the hydrogen generator 106 by preventing a faulty sensor from mis-measuring a gas level within the generator that may cause an unsafe operating condition.

At operation 504, the determined gas measurements may be compared to one or more rules of a stored ruleset. FIG. 4B illustrates one example of rule database 420 including a ruleset for operating a hydrogen generator 106 based on a gas measurement. The rule database 420 may include a rule number 422, a type of sensor associated with the rule 424, a measurement level 426 associated with the rule, and an operating rule 428. For example, rule 1 of the ruleset of FIG. 4B may apply to oxygen sensor readings within a range of values as determined from the historical database 400 to correspond to a notable increase in oxygen measurements. In such circumstances, the operating rule may be a to notify a user of increased oxygen levels in a hydrogen pipe of the generator 106. The application of the rules of the stored ruleset 420 is discussed in more detail below. To use the rule database 420, the determined gas measurement may be compared to the range of measurement values as noted in column 426 of the table. Further, as each rule 422 may be specific to the type of sensor 424 associated with each rule, the determined gas measurement may be associated with a particular type of gas sensor and compared to the sensor type column of the rule database 420 to ensure the proper sensor data measurement corresponds to the sensor from which the gas measurement is obtained.

At operation 506, it may be determined if the determined gas measurement meets or exceeds a measurement range 426 for a corresponding rule in the ruleset database 420. For example, a determined oxygen measurement value may be within a range of oxygen values noted as critical as received from an oxygen sensor. Through a comparison to the rules database 420, the determined oxygen measurement is within the rule measurement data range 426 for rule 3. Other gas measurements may be compared to the measurement ranges of the rules database 420 to determine if a measurement exceeds or meets the requirements for a rules threshold. If the measurement value is not within a range of values, no action may be taken to control the hydrogen generator 106 as the measured values of gases are within a safe or normal operating range. However, if the measurement value is within a range of values of the ruleset 420, the rule 428 corresponding to the measurement value and the type of sensor may be determined at operation 508.

At operation 510, it may be determined if the rule includes a system shutdown. For example, the rules database 420 of FIG. 4B includes a “Shut Down System” rule for an oxygen or hydrogen measurement. Thus, if the determined oxygen measurement value is within or exceeds a value of a shutdown range of values, the corresponding rule includes an instruction to shut down the hydrogen generator 106 from which the oxygen measurement was obtained. In such circumstances, a signal to shut down the corresponding hydrogen generator 106 may be transmitted in operation 514. For example, the control system 102 may determine the hydrogen generator 106 from which the gas measurement was received and transmit an instruction to the controller 114 of the hydrogen generator 106 to shut down the system. The controller 114 may, in some instances, receive the shut down signal and operate the hydrogen generator 106 into a shut down mode to prevent additional gases from being produced by the generator. The controller 114 may also preform one or more additional shut down operations to ensure a safe working condition for the generator. If, however, the determined rule does not include a shut down instruction, an alert or other message associated with the measured gas level of the hydrogen generator 106 may be transmitted in operation 512. For example, the control system 102 may transmit one or more alert signals to a receiver network 116 associated with the hydrogen generator 106. The transmitting alert may take any electronic messaging form, such as an electronic mail, an SMS text, a message through a reporting software, an entry in a system log, and the like. The alert may or may not request an acknowledgement to the alert from a receiving computing device or network. In general, any communication may be transmitted to any receiving device in response to the rule obtained from the rules database.

As discussed above, the hydrogen generator 106 may include any number of gas measuring sensors, including both a plurality of oxygen sensors 218 and/or a plurality of hydrogen sensors 220. In some instances, two or more sensors may correspond as redundant sensors to prevent an unsafe operating condition due to a failing sensor. Further, the redundant sensors may provide an indication of a failing sensor for replacement or maintenance and improve the accuracy of gas measurements within the hydrogen generator 106. For example, a first oxygen sensor 218 may associated with the oxygen processor 208 as described above to measure an output of oxygen from the processor. A second, redundant oxygen sensor may be located close to the first oxygen sensor 218 to obtain a second oxygen measurement. In general, the redundant oxygen sensor may be located in any position in relation to the first oxygen sensor, however, the redundant sensor may be located to obtain a measurement of a similar environment as the first sensor. Further, each sensor may be identified as corresponding to a redundant or paired sensor. In one instance, the hydrogen control application 312 may assign or otherwise maintain the identifiers of the sensors such that measurements of a sensor and the corresponding redundant sensor may be compared. Each sensor of the hydrogen generator 106 may have a corresponding redundant sensor. In some instances, however, gas measuring sensors that are included in the hydrogen generator 106 for safety purposes may include a corresponding redundant sensor, while other types of sensors may not include a redundant sensor.

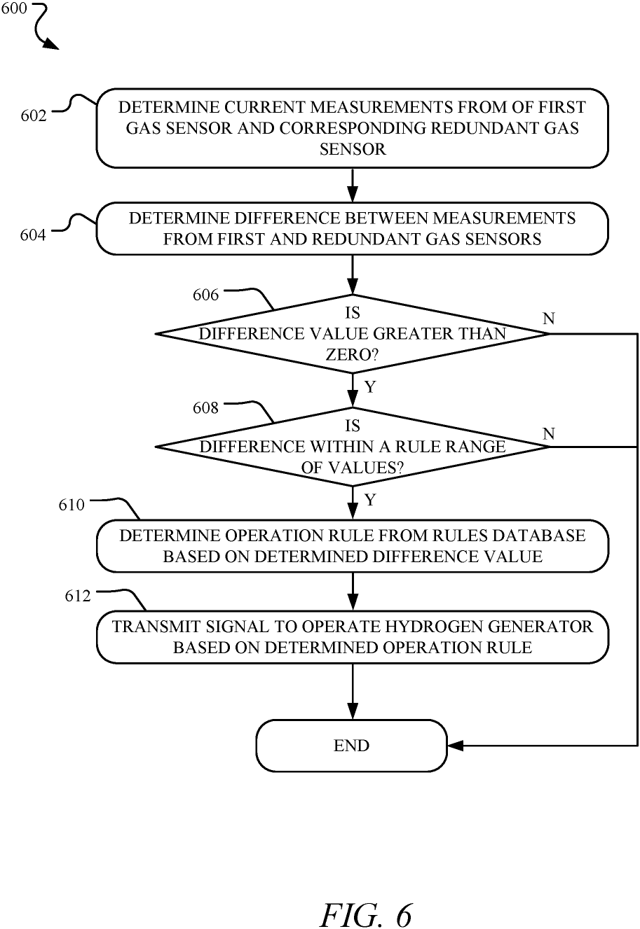

Measurements from both a sensor and the corresponding redundant sensor may be determined and compared to obtain an operating condition of the hydrogen generator 106 and/or detect an unsafe environment. For example, FIG. 6 illustrates a method 600 for utilizing a pair of redundant gas sensors of a hydrogen generator to ensure proper operation of the generator. In one implementation, the operations of the method 600 may be performed or executed by the gas sensor service 318 of the hydrogen control application 312 as executed by the control system 102. In general, however, the operations may be performed by any component or components of the hydrogen generation environment 100 of FIG. 1, including the controller 114 of the hydrogen generator 106 and/or a system of the receiver network 116.

At operation 602, the gas sensor service 318 of the hydrogen control application 312 may receive or otherwise obtain the measurements of the gas sensors. In one implementation, the gas sensor measurements may be obtained from a table of measurements, such as illustrated in table 400 of FIG. 4A. As mentioned above, each sensor may be associated with an identifier such that measurements received from the sensors may be attributed to corresponding sensors (e.g., a first sensor and a corresponding second, redundant sensor). Upon receipt or at some later time, the measurement of corresponding sensors may be compared to determine a difference, or delta, between the two measurements at operation 604. This delta may be utilized to determine one or more operating states or conditions of the hydrogen generator or components thereof. For example, an oxygen sensor 218 may provide a measurement of 10% oxygen at an output port of the oxygen processor 208. A redundant sensor corresponding to the oxygen sensor 218 may provide a similar measurement of 10% oxygen. In this instance, the determined difference between the main sensor and the redundant sensor indicate that each sensor is operating properly and the measurement can be relied upon. In particular, it may be determined if the difference between the main sensor measurement and the redundant sensor measurement is greater than zero. If not, such as when the measurements are the same, the method may end and the measurement obtained from either sensor may be used by the controller 114 or control system 102 as an accurate measurement.

However, in some circumstances, the determined difference between the main sensor and the redundant sensor may be greater than zero and may be indicative of a faulty sensor or other operational condition of the hydrogen generator 106. For example, an oxygen sensor 218 may provide a measurement of 10% oxygen while a redundant sensor corresponding to the oxygen sensor may provide a measurement of 20% oxygen. The disparity between the two measurements may be caused by many factors, such as a faulty sensor, an unexpected operation of the hydrogen generator 106, miscommunication between one or more of the sensors and the controller, or any other condition. Regardless of the cause, it may be determined if the difference between the main sensor and the redundant sensor measurements is within a rule range of values as set out in a corresponding ruleset. For example, a ruleset similar to that illustrated in FIG. 4B may be maintained that is indexed by a difference value rather than a sensor data value. Various operational rules may therefore correspond to one or more difference values or ranges of difference values. In one example, a difference of 10 may correspond to a shut down rule for the hydrogen generator 106. In another example, a difference of 5 may correspond to a rule to perform maintenance on one or more of the sensors as the determined difference may indicate a faulty sensor component. In still another example, a difference between 1-5 may correspond to a rule to alert a receiver network 116 of the disparity between the two sensor measurements. The rule may also instruct the controller 114 or the control system 102 to use the higher of the two measurements to use in method 500 discussed above. Thus, at operation 610, the determined difference between the main sensor and the redundant sensor may be used to determine an operational rule from a rules database. At operation 612, one or more control signals may be transmitted to operate the hydrogen generator 106 based on the determined rule. In one example, the control system 102 may determine the rule from the rule set and transmit the control signals to the controller 114 of the corresponding hydrogen generator 106. In another example, the controller 114 itself may determine the rule based on the difference between the main sensor and the redundant sensor and control the hydrogen generator 106 accordingly.

Some embodiments of the control system 102 or other computing device may utilize the historical measurements obtained from the oxygen sensors 218, hydrogen sensors 220, and/or any redundant sensors to calibrate one or more components of the hydrogen generator 106, determine a current operating condition of the hydrogen generator, estimate a future operating condition of the generator, forecast a drift in the measurements of the sensors, schedule a maintenance calendar to prevent a forecasted change in operation of the generator, and the like. In one particular implementation, databases of historical oxygen and/or hydrogen measurements from one or more hydrogen generators 106 may be maintained and processed, such as by the data analyzer 316 of the hydrogen control application 312 to obtain or determine data and information of the sensors or the hydrogen generating system itself. In general, any number of historical measurements and/or databases may be analyzed for such purposes.

In one example, processing of the historical databases of sensor measurements may be implemented through a machine-learning or artificial intelligent algorithm. For example, historical measurements of one or more gas sensors obtained before a change in an operational condition of the hydrogen generator 106 may be used to establish an initial model of the generator. Through an analysis of current gas measurements, a prediction of the same change in the operational condition of a hydrogen generator may be predicted before the occurrence of the change in condition. In response to the predicted change in operation, one or more procedures may be executed on the hydrogen generator 106, including altering one or more components or utilizing the controller 114 to change one or more parameters of the generator, before the predicted change in operation occurs. Further, the model of the hydrogen generator 106 based on the gas measurements from the sensors 218, 220 may be altered based on feedback received from the controller 114 or the control system 102 indicating an accuracy of the prediction of the operational change. For example, the one or more procedures may not be implemented on the hydrogen generator 106 in response to the gas measurements and the predicted operational change may occur, essentially verifying the relation between the gas measurements and the operational change. Alternatively, the feedback data may indicate that the prediction of the operational change was incorrect based on the gas measurements. In such circumstances, the model for hydrogen generator operation may be altered in response to the incorrect prediction to make the model more accurate. In one example, one or more parameters or weights given to the sensor measurements may be adjusted in response to the feedback data of the predicted operation of the generator. In this manner, the operational conditions of the hydrogen generator 106 may be predicted based on a machine-learning or artificial intelligent constructed model of the generator that utilizes one or more gas measurements as inputs to the model.

The historical gas measurements may also be utilized to alter one or more aspects of the rules of the rule set database 420 of FIG. 4B. For example, a first range of oxygen measurement values may be associated with a rule to notify a receiver network 104 as “critical” levels within a pipe. Through an analysis of the historical levels of oxygen measurements, however, it may be determined that a lower range of oxygen measurements values should be labeled as “critical” based on the operation of the hydrogen generator 106. In response to the analysis of the historical measurements, the range of measurement values associated with an alert of a critical level in the piper may be adjusted to a second range for measurements. In a similar manner, a range of measurement values may be adjusted for a shut down rule for the hydrogen generator. In general, any rule, measurement value, or range of measurement values may be adjusted based on one or more historic measurement values received from a gas sensor.

In still another example, a drift in the measurement of one or more of the gas sensors may be predicted (based on historical measurement values) and one or more rules may be established accounting for the drift in the sensor measurements. Over time, an accuracy of a gas sensor may drift as the sensor ages. A drift in accuracy may be detected by the hydrogen system through the comparison of the measurements of the gas sensor to the corresponding redundant sensor as the two measurements may diverge over time. The gradual divergence of the measurements may be tracked through an analysis of the historical measurements of the gas measurements and/or the historical difference between the measurements of a first gas sensor and the measurements of the corresponding redundant gas sensor. A model for the drifting of the accuracy of a gas sensor may be generated based on this historical data. Further, the expected or modeled drift in accuracy may be used to modify or alter one or more rules for addressing a detected difference in the measurements of the first gas sensor and the measurements of the corresponding redundant gas sensor. For example, an initial threshold value for a particular rule may be included in a rule set for a determined difference between measurements of a first gas sensor and the measurements of the corresponding redundant gas sensor. After a period of time, the initial threshold value may be adjusted to include a predicted drift in the gas sensor measurements such that erroneous rules are not implemented based on the drift. In another example, a drift of the gas measurements may be used to schedule a replacement of a drifting sensor for some time in the future, estimated by the model for determining the drift of the sensor. In still another example, one or more of the sensors may be self-calibrating based on an instruction from the controller 114. The amount that each sensor may self-calibrate may be based on an analysis of the historical measurements obtained by the sensor and a detected drift in the measurement accuracy. In this manner, the historical measurements and determined differences of measurements of the first gas sensor and the measurements of the corresponding redundant gas sensor may be utilized to alter components of the hydrogen generator or rule sets for operating said generator.

Further still, the measurements obtained from the gas sensors 218, 220 may be combined with other diagnostic measurements of the hydrogen generator 106 to determine a more accurate account of the operational conditions of the generator. For example, the controller 114 or other components of the hydrogen generator 106 may utilize an alternating current (AC) impedance spectroscopy diagnostic technique to monitor for leakage, errors, deterioration, and overall life quality of a hydrogen generator using a small AC ripple across a direct current (DC) power input and measuring the frequency of the resultant impedance wave. In some embodiments, the AC ripple may sweep through set frequencies and gather data to analyze against predetermined errors and the system may be corrected to clear the error and/or the error may be reported. One particular example of a system and process for using an AC impedance spectroscopy diagnostic technique is described in U.S. Pat. Application Ser. No. 17/360,153, entitled “IMPEDANCE MONITORING OF A MODULAR ELECTROLYSIS SYSTEM” by Srinivasan et al., the entire contents of which is incorporated herein by reference.

The gas measurements received from the gas sensors 218, 220 may be combined with any other diagnostic measurements of the hydrogen generator 106. For example, analysis of the AC impedance spectroscopy may indicate one or more faults of the hydrogen generator 106, such as a dryout condition in which the electrolyzer 108 is improperly moisturized, impurities in an inlet stream of water to the electrolyzer, flooding of the electrolyzer, and the like. For each detected operating condition of the hydrogen generator 106, an analysis of the gas measurements from sensors 218, 220 may also be executed to verify the operational condition indicated by the AC impedance spectroscopy. In particular, as the operating conditions of the electrolyzer 108 are altered due to a change in one or more conditions of the generator 106, the percentage of oxygen and/or hydrogen generated within the mechanisms of the generator may be altered. These changes in the gas composition of the hydrogen generator 106 may be measured by one or more gas sensors of the generator. Further, a response to the detected condition of the generator 106 may be dependent upon the measurements of the gas sensors 218, 220 in combination with the other diagnostic measurements. For example, a remedial operation for the generator 106 may be executed only upon a verification of the operational condition through the analysis of the gas measurements in addition to another diagnostic measurement, or vice versa.

The received measurements from the gas sensors 218, 220 may also be analyzed with other diagnostic measurements to determine an operating state of the hydrogen generator. For example, Open Circuit Voltage (OCV) measurements may be obtained or otherwise determined from the electrochemical stack 216 to determine if the stack is degrading or if there are faulted cells within the stack that may lead to a leakage scenario. OCV measurements may predict such a scenario and confirmation of a high likelihood of the leakage may be verified through the use of the oxygen sensors 218 and/or the hydrogen sensors 220, as discussed above.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present systems and methods, which, as a matter of language, might be said to fall therebetween.

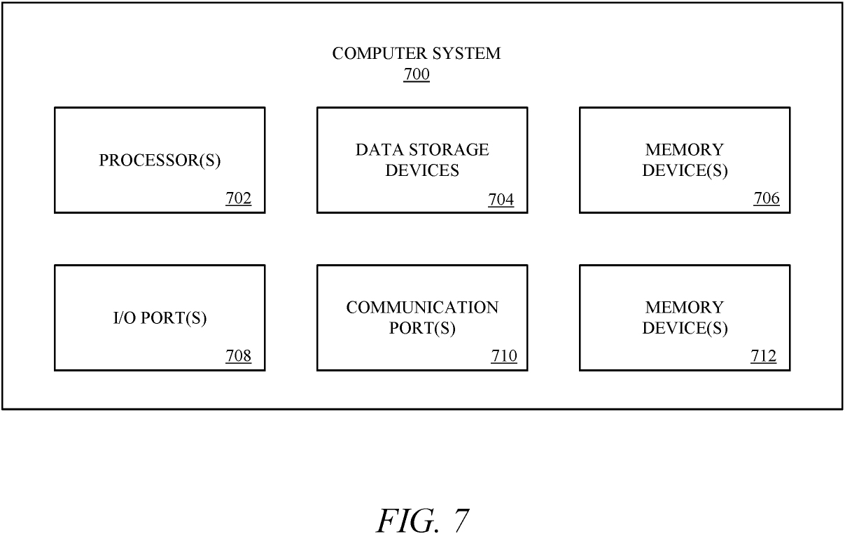

Referring to FIG. 7, a detailed description of an example computing system 700 having one or more computing units that may implement various systems and methods discussed herein is provided. The computing system 700 may be part of a controller 114, may be in operable communication with various implementation discussed herein, may run various operations related to the method discussed herein, and may be part of overall systems discussed herein. The computing system 700 may be applicable to, for example, the controller 114 discussed with respect to the various figures and may be used to implement the various methods described herein. It will be appreciated that specific implementations of these devices may be of differing possible specific computing architectures, not all of which are specifically discussed herein but will be understood by those of ordinary skill in the art. It will further be appreciated that the computer system may be considered and/or include an ASIC, FPGA, microcontroller, or other computing arrangement. In such various possible implementations, more or fewer components discussed below may be included, interconnections and other changes made, as will be understood by those of ordinary skill in the art.

The computer system 700 may be a computing system that is capable of executing a computer program product to execute a computer process. Data and program files may be input to the computer system 700, which reads the files and executes the programs therein. Some of the elements of the computer system 700 are shown in FIG. 7, including one or more hardware processors 702, one or more data storage devices 704, one or more memory devices 706, and/or one or more ports 708-712. Additionally, other elements that will be recognized by those skilled in the art may be included in the computing system 700 but are not explicitly depicted in FIG. 7 or discussed further herein. Various elements of the computer system 700 may communicate with one another by way of one or more communication buses, point-to-point communication paths, or other communication means not explicitly depicted in FIG. 7. Similarly, in various implementations, various elements disclosed in the system may or not be included in any given implementation.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The presently described technology in various possible combinations may be implemented, at least in part, in software stored on the data stored device(s) 704, stored on the memory device(s) 706, and/or communicated via one or more of the ports 708-712, thereby transforming the computer system 700 in FIG. 7 to a special purpose machine for implementing the operations described herein.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 700 includes one or more ports, such as an input/output (I/O) port 708, a communication port 710, and a sub-systems port 712, for communicating with other computing, network, or vehicle devices. It will be appreciated that the ports 708-712 may be combined or separate and that more or fewer ports may be included in the computer system 700. The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. In some examples, such inputs may be distinct from the various system and method discussed with regard to the preceding figures. Similarly, the output devices may convert electrical signals received from computing system 700 via the I/O port 708 into signals that may be sensed or used by the various methods and system discussed herein. The input device may be an alphanumeric input device, including alphanumeric and other keys for communicating information and/or command selections to the processor 702 via the I/O port 708.

The environment transducer devices convert one form of energy or signal into another for input into or output from the computing system 700 via the I/O port 708. For example, an electrical signal generated within the computing system 700 may be converted to another type of signal, and/or vice-versa. In one implementation, the environment transducer devices sense characteristics or aspects of an environment local to or remote from the computing device 700.

In one implementation, a communication port 710 may be connected to a network by way of which the computer system 700 may receive network data useful in executing the methods and systems set out herein as well as transmitting information and network configuration changes determined thereby. The communication port 710 connects the computer system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 710 to communicate with one or more other machines, either directly over a point-to-point communication path, over a wide area network (WAN) (e.g., the Internet), over a local area network (LAN), over a cellular (e.g., third generation (3G), fourth generation (4G), fifth generation (4G)) network, or over another communication means.

The system set forth in FIG. 7 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Various embodiments of the disclosure have been discussed in detail. While specific implementations are discussed, it should be understood that this is done for illustration purposes only. A person skilled in the relevant art will recognize that other components and configurations may be used without parting from the spirit and scope of the disclosure. Thus, the description and drawings herein are illustrative and are not to be construed as limiting. Numerous specific details are described to provide a thorough understanding of the disclosure. However, in certain instances, well-known or conventional details have not been described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Thus, references to one or an embodiment in the present disclosure can be references to the same embodiment or any embodiment; and such references mean at least one of the embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.”

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition’s nature or characteristics would be permissible if present under the “consisting essentially of” language, even though not expressly recited in a list of items following such terminology. In this specification when using an open ended term, like “comprising” or “including,” it is understood that direct support should be afforded also to “consisting essentially of” language as well as “consisting of” language as if stated explicitly and vice versa.

What is claimed is:

1. A hydrogen generation system comprising:
a hydrogen generator comprising:
an electrochemical stack; and
a plurality of sensors measuring a concentration of hydrogen, oxygen, or a combination thereof generated from the electrochemical stack; and
a control system comprising a processor and a non-transitory computer-readable medium encoded with instructions, which when executed by the processor, cause the processor to:
determine an operational status of the hydrogen generator based on the concentration of gas generated from the electrochemical stack;
verify the operational status of the hydrogen generator through an additional diagnostic measurement of the electrochemical stack;
obtain, based on a value of the concentration of gas generated from the electrochemical stack, a rule from a ruleset database; and
execute a rule from a ruleset to alter an operational parameter of the electrochemical stack based on the determined operational status of the hydrogen generator.

2. The hydrogen generation system of claim 1, wherein the plurality of sensors comprise an oxygen sensor measuring a concentration of output oxygen generated from the electrochemical stack and a hydrogen sensor measuring a concentration of output hydrogen generated from the electrochemical stack.

3. The hydrogen generation system of claim 1, wherein the additional diagnostic measurement of the electrochemical stack comprises an alternating current impedance spectroscopy measurement.

4. The hydrogen generation system of claim 1, wherein the plurality of sensors comprises a first gas sensor and a corresponding redundant second gas sensor, the first gas sensor and the redundant second gas sensor located in proximity to each other.

5. The hydrogen generation system of claim 4, wherein the instructions cause the processor to:
determine a difference between a first gas concentration measurement from the first gas sensor and a second gas concentration measurement from the redundant second gas sensor; and
obtain, based on the determined difference and from a database of a redundant sensor rule set, an operational rule for controlling the hydrogen generator.

6. The hydrogen generation system of claim 5, wherein the instructions cause the processor to:
execute the operational rule for controlling the hydrogen generator in response to the determined difference between the first gas concentration measurement from the first gas sensor and the second gas concentration measurement from the redundant second gas sensor.

7. The hydrogen generation system of claim 5, wherein the database of the redundant sensor rule set comprises a plurality of redundant sensor rules each associated with one or more threshold values of the determined difference between the first gas concentration measurement from the first gas sensor and the second gas concentration measurement from the redundant second gas sensor.

8. The hydrogen generation system of claim 5, wherein the operational rule for controlling the hydrogen generator comprises an automatic shut down operation of the electrochemical stack.

9. The hydrogen generation system of claim 5, wherein the operational rule for controlling the hydrogen generator comprises causing at least one of the plurality of sensors to self-calibrate based on the determined difference between the first gas concentration measurement from the first gas sensor and the second gas concentration measurement from the redundant second gas sensor.

10. The hydrogen generation system of claim 5, wherein the instructions cause the processor to:
generate a model of the hydrogen generator based on one or more historical gas concentration measurements of the electrochemical stack; and
alter a parameter of the model based on the determined difference between the first gas concentration measurement from the first gas sensor and the second gas concentration measurement from the redundant second gas sensor.

11. A method for operating a hydrogen generation system, the method comprising:
receiving, from a plurality of sensors measuring a concentration of hydrogen, oxygen, or a combination thereof generated from an electrochemical stack;
determining, an operational status of the electrochemical stack based on the received measurements of concentration of gas;
verifying the operational status of the hydrogen generator through an additional diagnostic measurement of the electrochemical stack;
obtaining, based on a value of the concentration of gas generated from the electrochemical stack, a rule from a ruleset database; and
executing a rule from a ruleset to alter an operational parameter of the electrochemical stack based on the determined operational status of the hydrogen generator.

12. The method of claim 11, wherein the plurality of sensors comprise an oxygen sensor measuring a concentration of output oxygen generated from the electrochemical stack and a hydrogen sensor measuring a concentration of output hydrogen generated from the electrochemical stack.

13. The method of claim 11, wherein the additional diagnostic measurement of the electrochemical stack comprises an alternating current impedance spectroscopy measurement.

14. The method of claim 11, wherein the plurality of sensors comprises a first gas sensor and a corresponding redundant second gas sensor, the first gas sensor and the redundant second gas sensor located in proximity to each other.

15. The method of claim 14, further comprising:
determining a difference between a first gas concentration measurement from the first gas sensor and a second gas concentration measurement from the redundant second gas sensor;
obtaining, based on the determined difference and from a database of a redundant sensor rule set, an operational rule for controlling the hydrogen generator; and
executing the operational rule for controlling the hydrogen generator in response to the determined difference between the first gas concentration measurement from the first gas sensor and the second gas concentration measurement from the redundant second gas sensor.

16. The method of claim 15, further comprising:
generating a model of the hydrogen generator based on one or more historical gas concentration measurements of the electrochemical stack; and
altering a parameter of the model based on the determined difference between the first gas concentration measurement from the first gas sensor and the second gas concentration measurement from the redundant second gas sensor.

17. A non-transitory computer-readable storage medium having computer-executable program instructions stored thereon that when executed by a processor, cause a computing device to perform:
receiving, from a plurality of sensors measuring a concentration of hydrogen, oxygen, or a combination thereof generated from an electrochemical stack;
determining, an operational status of the electrochemical stack based on the received measurements of concentration of gas;
verifying the operational status of the hydrogen generator through an additional diagnostic measurement of the electrochemical stack;
obtaining, based on a value of the concentration of gas generated from the electrochemical stack, a rule from a ruleset database; and
executing a rule from a ruleset to alter an operational parameter of the electrochemical stack based on the determined operational status of the hydrogen generator.

18. The non-transitory computer-readable storage medium of claim 17, wherein the plurality of sensors comprise an oxygen sensor measuring a concentration of output oxygen generated from the electrochemical stack and a hydrogen sensor measuring a concentration of output hydrogen generated from the electrochemical stack.

19. The non-transitory computer-readable storage medium of claim 17, wherein the additional diagnostic measurement of the electrochemical stack comprises an alternating current impedance spectroscopy measurement.

20. The non-transitory computer-readable storage medium of claim 17, wherein the plurality of sensors comprises a first gas sensor and a corresponding redundant second gas sensor, the first gas sensor and the redundant second gas sensor located in proximity to each other.
